(19) United States
(12) Patent Application Publication
(10) Pub. No.: US 2007/0289652 A1
(43) Pub. Date: Dec. 20, 2007

(54) HIGH FLOW SURFACE MOUNT COMPONENTS

(75) Inventors: William J. Curran, Saratoga, CA (US); Dane C. Scott, Doylestown, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Matheson Tri-Gas, Longmont, CO (US)

(21) Appl. No.: 11/424,815

(22) Filed: Jun. 16, 2006

(51) Int. Cl. F17D 1/00

(52) U.S. Cl. 137/884

(57) ABSTRACT

A fluid handling unit is disclosed and includes a body, a plurality of fluid passage ports formed in the body, and a plurality of orifices formed on surfaces of the body to provide fluid access to the ports from outside the unit. At least two of the orifices may have different cross-sectional areas. A modular fluid handling system is also disclosed and includes a plurality of fluid handling units, wherein adjacent fluid handling units are coupled together to form the fluid handling system. The fluid handling system may deliver fluid from at least one fluid source to fluid utilizing equipment. A plurality of fluid passages may be formed by the fluid handling units, and the diameter of one fluid passage may be greater than the diameter of another fluid passage. At least one control component may be coupled with at least one fluid handling unit.

### BACKGROUND OF THE INVENTION

Typically, fluid sources and fluid utilizing equipment are connected to each other using fluid handling assemblies. These assemblies allow for control, regulation, and mixing of fluids which are delivered to fluid utilizing equipment. Conveniently, these systems are modular so they may be easily constructed and employ industry standard control components. Typical assemblies known in the art are discussed in U.S. Pat. No. 6,298,881, entitled “MODULAR FLUID HANDLING ASSEMBLY AND MODULAR FLUID HANDLING UNITS WITH DOUBLE CONTAINMENT” to William J. Curran et al. and U.S. Pat. No. 6,283,155, entitled “SYSTEM OF MODULAR SUBSTRATES FOR ENABLING THE DISTRIBUTION OF PROCESS FLUIDS THROUGH REMOVABLE COMPONENTS” to Kim Ngoc Vu.

However, these, and other modular systems are limited in their capabilities because they only allow for regulation of one size of fluid stream, or combination of multiple similar sized streams into another similar sized stream. This can result in combined streams with excessive pressures. As a solution, non-modular components may be used to allow combinations of multiple similar sized streams into a larger sized stream formed by the non-modular components. These systems may avoid the pressure increases associated with the wholly modular systems which provide configurations using only one size stream, but have several disadvantages.

Non-modular components are more likely to leak because of the fabrication processes involved in assembling the non-modular components together, and to standardized modular components. Additionally, such constructions take up more space, and require a greater and varied stock of non-standardized replacement parts for common maintenance, which may not be used to replace faulty modular components within other parts of such fluid handling systems. This results in increased maintenance and repair costs to fluid handling systems which translates to increased possible downtime and disruption to revenue producing equipment.

### BRIEF SUMMARY OF THE INVENTION

In one embodiment, a fluid handling unit is provided. The fluid handling unit may include a body, a plurality of fluid passage ports formed in the body, and a plurality of orifices formed on surfaces of the body to provide fluid access to the ports from outside the unit. At least two of the orifices may have different cross-sectional areas. The fluid handling unit may have a front face, a back face, and a top face. There may be one or more input orifices on the front face of the body, one or more output orifices on the back face of the body, and one or more control orifices on the top face of the body. The top face of the body may be adapted to be reversibly coupled with a control component having at least one component orifice. The front face of the body of the first fluid handling unit may be adapted to be reversibly coupled with a back face of a body of a second fluid handling unit. The back face of the body of the first fluid handling unit may be adapted to be reversibly coupled with a front face of a body of a second fluid handling unit.

In another embodiment, a modular fluid handling system is provided. The fluid handling system may include a plurality of fluid handling units, wherein adjacent fluid handling units may be coupled together to form the fluid handling system. The fluid handling system may deliver fluid from at least one fluid source to fluid utilizing equipment. A plurality of fluid passages may be formed from the coupled plurality of fluid handling units and the diameter of at least one fluid passage may be greater than the diameter of at least one other fluid passage. At least one control component may be coupled with at least one of the fluid handling units.

In another embodiment, a fluid delivery manifold is provided. The fluid delivery manifold may include a plurality of fluid handling units, wherein adjacent fluid handling units may be coupled together to form the fluid delivery manifold. The fluid delivery manifold may deliver fluid from a plurality of fluid sources to a piece of fluid utilizing equipment. A high-flow fluid passage may be coupled with the fluid utilizing equipment and possibly be formed by two or more of the fluid handling units. A plurality of low-flow fluid passages may be in fluid communication with the high-flow fluid passage and the plurality of fluid sources, wherein the low-flow fluid passages may be formed by two or more of the fluid handling units and have a smaller diameter than the high-flow fluid passage. At least one control component may be coupled with each of the low-flow fluid passages, wherein the control component may regulate a rate of fluid flow from the low-flow fluid passages to the high-flow passage.

In another embodiment, a different fluid delivery manifold is provided. The fluid delivery manifold may include a plurality of fluid handling units, wherein adjacent fluid handling units may be coupled together to form the fluid delivery manifold. The fluid delivery manifold may deliver fluid from a fluid source to a plurality of pieces of fluid utilizing equipment. A high-flow fluid passage may be coupled with the fluid source and possibly be formed by two or more of the fluid handling units. A plurality of low-flow fluid passages may be in fluid communication with the high-flow fluid passage and the plurality of pieces of fluid utilizing equipment, wherein the low-flow fluid passages may be formed by two or more of the fluid handling units and have a smaller diameter than the high-flow fluid passage. At least one control component may be coupled with each of the low-flow fluid passages, wherein the control component may regulate a rate of fluid flow to the low-flow fluid passages from the high-flow fluid passage.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

The present invention is described in conjunction with the appended figures:

FIG. 1A shows a top view of one possible fluid handling unit of the invention having a first small fluid passage port accessible by an input orifice and a control orifice; a second small fluid passage port accessible by a control orifice; and a large fluid passage port accessible by an input orifice and an output orifice, and in fluid communication with the second small fluid passage port;

FIG. 1B shows a front view of the fluid handling unit of FIG. 1A;

FIG. 1C shows a side view of the fluid handling unit of FIG. 1A and FIG. 1B;

FIG. 2A shows a top view of another possible fluid handling unit of the invention similar to that shown in FIG. 1A, except with the first small fluid passage port in a different position within the fluid handling unit;

FIG. 2B shows a front view of the fluid handling unit of FIG. 2A;

FIG. 2C shows a side view of the fluid handling unit of FIG. 2A and FIG. 2B;

FIG. 3A shows a top view of another possible fluid handling unit of the invention similar to that shown in FIG. 1A, except also having a third small fluid passage port proceeding through the fluid handling unit from an input orifice to an output orifice;

FIG. 3B shows a front view of the fluid handling unit of FIG. 3A;

FIG. 3C shows a side view of the fluid handling unit of FIG. 3A and FIG. 3B;

FIG. 4A shows a top view of another possible fluid handling unit of the invention having a first small fluid passage port accessible by an input orifice and an output orifice; a second small fluid passage port accessible by an input orifice and an output orifice; a first large fluid passage port accessible by an input orifice; and a second large fluid passage port accessible by an output orifice;

FIG. 4B shows a front view of the fluid handling unit of FIG. 4A;

FIG. 4C shows a side view of the fluid handling unit of FIG. 4A and FIG. 4B;

FIG. 5A shows a top view of a modular fluid handling system which includes the fluid handling units from FIG. 2C, FIG. 3C, and FIG. 4C coupled together to form a plurality of fluid flow passages;

FIG. 5B shows a side view of the modular fluid handling system of FIG. 5A;

FIG. 6 shows a side view of the modular fluid handling system of FIG. 5A with control components attached;

FIG. 7 shows an isometric view of another possible fluid handling unit of the invention similar to that shown in FIG. 4A, FIG. 4B and FIG. 4C, except having extensions with cavities on the front, back and top of the fluid handling unit that allow for reversible coupling of the fluid handling unit to other fluid handling units, as well as recesses for mechanical seals; and

FIG. 8 shows an isometric view of two of the fluid handling units from FIG. 7 situated in an orientation as they may be coupled together in some embodiments of the invention.

### DETAILED DESCRIPTION OF THE INVENTION

Fluid handling units are described for assembling modular fluid handling systems capable of handling and controlling the flow of fluids. The fluids handled and controlled may be liquids or gases. In some applications, fluids used for the fabrication of semi-conductors or other electronic devices may be handled and controlled by the modular fluid handling systems. The modular fluid handing systems may deliver fluids from one or more fluid sources to one or more pieces of fluidizing utilizing equipment, or sub-components thereof. In other embodiments, a modular fluid delivery manifold is described. In some of these embodiments, multiple low-flow fluid streams may be combined into a high-flow fluid stream. In other types of these embodiments, a high-flow fluid stream may be separated into multiple low-flow fluid streams.

In one embodiment, a fluid handling unit is provided. The fluid handling unit may include a body with a plurality of fluid passage ports formed in the body. In some embodiments the body may be made from a metal such as aluminum; steel; stainless steel or other alloy; a composite such as carbon fiber; ceramic; and/or a polymer or plastic. A plurality of orifices formed on the surfaces of the body may provide fluid access to the ports from outside the unit. At least two of the orifices may have different cross-sectional areas. In some embodiments, the orifices and ports may be generally circular in cross-section and have diameters in the range of about 0.5 inches to about 3.0 inches. In exemplary embodiments, the orifices and ports may be generally circular in cross-section and have diameters in the range of about 0.1 inches to about 1.0 inches. In preferred embodiments, the orifices and ports may be generally circular in cross-section and have diameters in the range of about 0.170 inches to about 0.240 inches. In some embodiments, at least two of the orifices may be circular and have different diameters.

In various embodiments of the fluid handling unit, the body may have a front face, a back face, and a top face. There may be one or more input orifices on the front face, one or more output orifices on the back face, and one or more control orifices on the top face. At least one of the fluid passage ports may be accessible by the input orifice and the output orifice. At least one of the fluid passage ports may be accessible by the control orifice.

The top face of the body may be adapted to be reversibly coupled with a control component having at least one component orifice. When the top face of the body is reversibly coupled with the control component, at least one control orifice may be in fluid communication with at least one component orifice. A mechanical seal may be disposed between the first fluid handling unit and the control component to leak tightly couple the first fluid handling unit and the control component. The mechanical seal may be, for example, a chemical adhesive, a chemical sealant, a gasket, an o-ring, a c-ring, a w-seal and/or other metallic seal. Control components may, for example, be such mechanisms as a valve, a flow regulator, a pressure regulator, a restrictive flow orifice, a purifier, a flow controller, a filter, a gauge, a sensor, a branch connector, and/or a mechanical indicator. In some embodiments, control components may have a generally square coupling flange with each side of the square coupling flange being either about 1.5 inches, about 1.25 inches, or about 1.125 inches long. Various coupling methods may be used to couple control components with the body. For example, bolts, nuts, machine screws, threaded cavities, cam-locking mechanisms and/or chemical adhesives are a few of the possible coupling methods. In some embodiments, multiple sets of threaded cavities or other coupling methods may be located on the body so as to allow different sized coupling flanges to be mounted on the same body. For example, through the use of different sets of threaded cavities in a body, different sized control components, possibly with different sized coupling flanges, may be attached to the body by using each of the different sets of threaded cavities.

The front face of the body of the fluid handling unit may be adapted to be reversibly coupled with a back face of a body of a second fluid handling unit, the secondary fluid handling unit having at least one output orifice. When coupled, at least one input orifice of the fluid handling unit may be in fluid communication with at least one output orifice of the secondary fluid handling unit. A mechanical seal may be disposed between the fluid handling unit and the secondary fluid handling unit to leak tightly couple the fluid handling unit and the secondary fluid handling unit.

The back face of the body of the fluid handling unit may be adapted to be reversibly coupled with a front face of a body of a secondary fluid handling unit, the secondary fluid handling unit having at least one input orifice. When coupled, at least one output orifice of the fluid handling unit may be in fluid communication with at least one input orifice of the secondary fluid handling unit. A mechanical seal may be disposed between the fluid handling unit and the secondary fluid handling unit to leak tightly couple the fluid handling unit and the secondary fluid handling unit.

In another embodiment, a modular fluid handling system is described. The modular fluid handling system may include a plurality of fluid handling units, where adjacent fluid handling units may be coupled together to form the fluid handling system. The fluid handling system may deliver fluid from at least one fluid source to fluid utilizing equipment through a plurality of fluid passages which may be formed from the coupled plurality of fluid handling units. The diameter of at least one fluid passage may be greater than the diameter of at least one other fluid passage and at least one control component may be coupled with at least one of the fluid handling units.

In these embodiments, at least one fluid passage may extend through the plurality of fluid handling units. At least one fluid passage may be in fluid communication with at least one other fluid passage. The fluid communication may occur at least in part through the control component. A mechanical seal may be disposed between adjacent fluid handling units to leak tightly couple adjacent fluid handling units together. At least one fluid passage in these embodiments may be coupled with the fluid source. At least one other fluid passage may be coupled with the fluid utilizing equipment.

In some embodiments a relatively warm or cold fluid may flow through at least one fluid port and/or fluid passage within the plurality of fluid handling units. These temperate fluids may be intended to warm or cool the other fluids flowing via heat conduction through any one or more of the fluid handling units. Alternatively, these temperate fluids may flow through the plurality of fluid handling units so as to be delivered at a piece of fluid utilizing equipment that utilizes the temperate fluid.

In another embodiment, a fluid delivery manifold is described. The fluid delivery manifold may include a plurality of fluid handling units, where adjacent fluid handling units may be coupled together to form the fluid delivery manifold. The fluid delivery manifold may deliver fluid from a plurality of fluid sources to a piece of fluid utilizing equipment.

In these embodiments, a high-flow fluid passage, possibly formed by two or more of the fluid handling units, may be coupled with the fluid utilizing equipment. A plurality of low-flow fluid passages, which may be formed by two or more of the fluid handling units, may be in fluid communication with the high-flow fluid passage and the plurality of fluid sources. The low-flow fluid passages may have a smaller diameter than the high-flow fluid passage. At least one control component may be coupled with each of the low-flow fluid passages, wherein the control component may regulate a rate of fluid flow from the low-flow fluid passage to the high-flow passage.

In another embodiment, a different fluid delivery manifold is described. The fluid delivery manifold may include a plurality of fluid handling units, where adjacent fluid handling units may be coupled together to form the fluid delivery manifold. The fluid delivery manifold may deliver fluid from a fluid source to a plurality of pieces of fluid utilizing equipment.

In these embodiments, a high-flow fluid passage, possibly formed by two or more of the fluid handling units, may be coupled with the fluid source. A plurality of low-flow fluid passages, which may be formed by two or more of the fluid handling units, may be in fluid communication with the high-flow fluid passage and the plurality of pieces of fluid utilizing equipment. The low-flow fluid passages may have a smaller diameter than the high-flow fluid passage. At least one control component may be coupled with each of the low-flow fluid passages, wherein the control component regulates a rate of fluid flow to the low-flow fluid passages from the high-flow fluid passage.

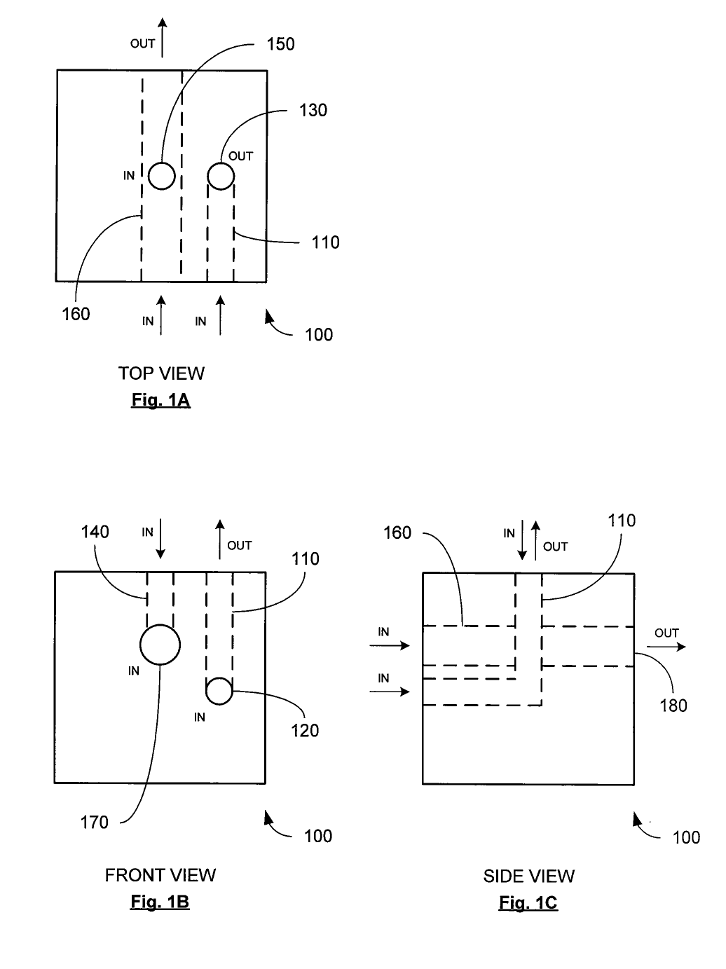

In FIG. 1A, FIG. 1B and FIG. 1C, a fluid handling unit 100 is shown from three different views (top, front and side, respectively). In this embodiment, the fluid handling unit 100 has a first small fluid passage port 110 accessible by an first input orifice 120 and a first control orifice 130; a second small fluid passage port 140 accessible by a second control orifice 150; and a large fluid passage port 160 accessible by a second input orifice 170 and an output orifice 180, and in fluid communication with the second small fluid passage port 140.

In one possible application of the fluid handling unit 100, fluid ‘A’ flows into input orifice 170, and fluid ‘B’ flows into input orifice 120. The fluids may flow into fluid handling unit 100, for example, from a fluid source or equipment delivering the fluid from a fluid source, possibly another fluid handling unit. Fluid ‘B’ will flow from input orifice 120, through first small fluid passage port 110, and to first control orifice 130. A control component may be reversibly coupled to the top of the fluid handling component 100 and may direct and regulate the flow of fluid ‘B’ from first control orifice 130 to second control orifice 150. The control component may, for example, be a valve, a flow regulator, a pressure regulator, a restrictive flow orifice, a purifier, a flow controller, a filter, a gauge, a sensor a branch connector and/or a mechanical indicator.

The regulated flow of fluid ‘B’ may then flow from second control orifice 150, through second small fluid passage port 140, and into large fluid passage port 160 mixing with fluid ‘A’ to make the mixed fluid ‘A+B’. Mixed fluid ‘A+B’ may then flow through large fluid passage port 160 to output orifice 180. From the output orifice 180, the mixed fluid ‘A+B’ may be delivered, for example, to a piece of fluid utilizing equipment or possibly another fluid handling unit. Those skilled in the art will recognize that because large fluid passage port 160 is larger than small fluid passage port 110, combining fluids from small fluid passage port 110 into large fluid passage port 160 will produce less pressure in the large fluid passage port 160 than if the combined fluids were mixed into a smaller fluid passage port.

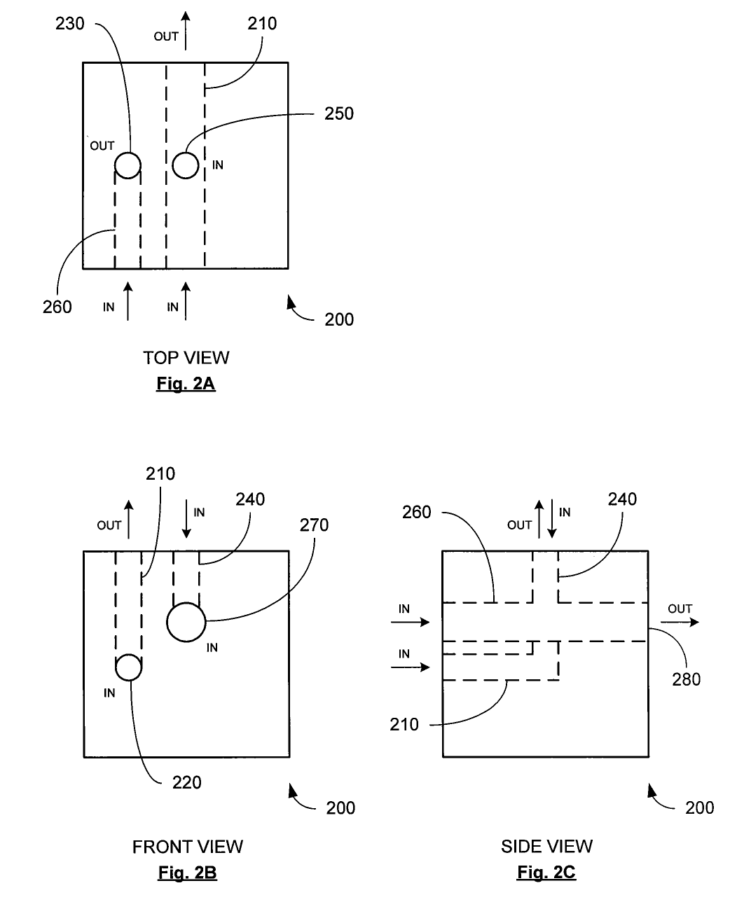

In FIG. 2A, FIG. 2B and FIG. 2C, a different fluid handling unit 200 is shown from three different views (top, front and side, respectively). This embodiment is similar to that shown in FIG. 1A, FIG. 1B and FIG. 1C, except the first small fluid passage port is in a different location within the body. In this embodiment, the fluid handling unit 200 has a first small fluid passage port 210 accessible by an first input orifice 220 and a first control orifice 230; a second small fluid passage port 240 accessible by a second control orifice 250; and a large fluid passage port 260 accessible by a second input orifice 270 and an output orifice 280, and in fluid communication with the second small fluid passage port 240.

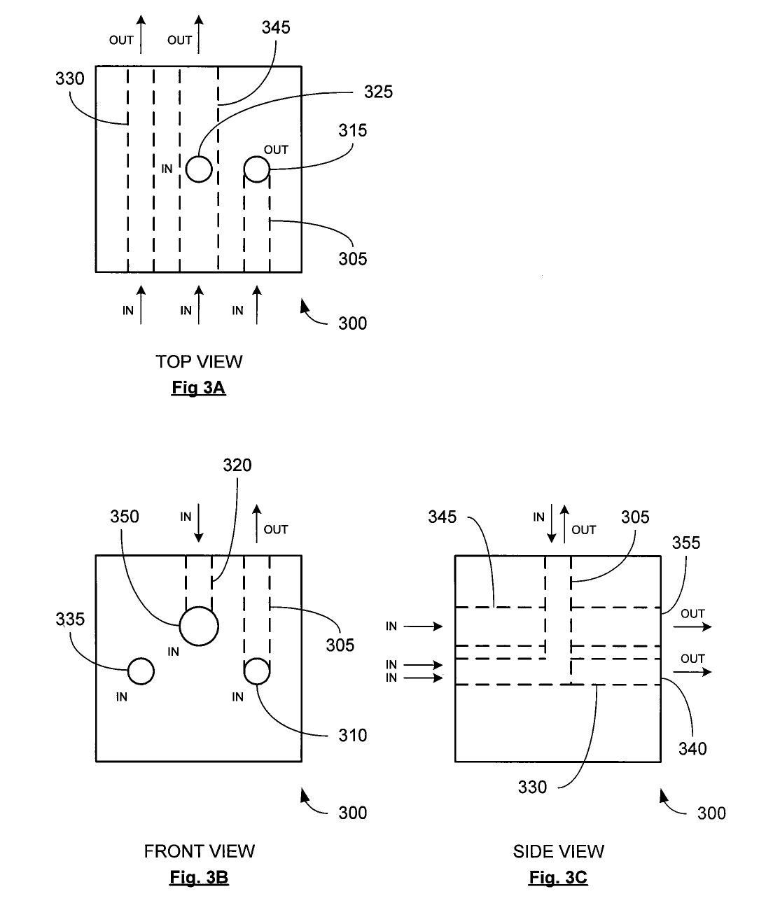

In FIG. 3A, FIG. 3B and FIG. 3C, another fluid handling unit 300 is shown from three different views (top, front and side, respectively). This embodiment is similar to that shown in FIG. 1A, FIG. 1B and FIG. 1C, except also having a third small fluid passage port proceeding through the fluid handling unit from an additional input orifice to an additional output orifice. In this embodiment, the fluid handling unit 300 has a first small fluid passage port 305 accessible by a first input orifice 310 and a first control orifice 315; a second small fluid passage port 320 accessible by a second control orifice 325; a third small fluid passage port 330 accessible by a second input orifice 335 and a first output orifice 340; and a large fluid passage port 345 accessible by a third input orifice 350 and a second output orifice 355, and in fluid communication with the second small fluid passage port 320. Fluid handling unit 300 allows for similar handling of fluids that fluid handling unit 100 allows, except fluid handling unit 300 also allows for an additional fluid ‘C’ to be delivered across fluid handling unit 300 without control or regulation.

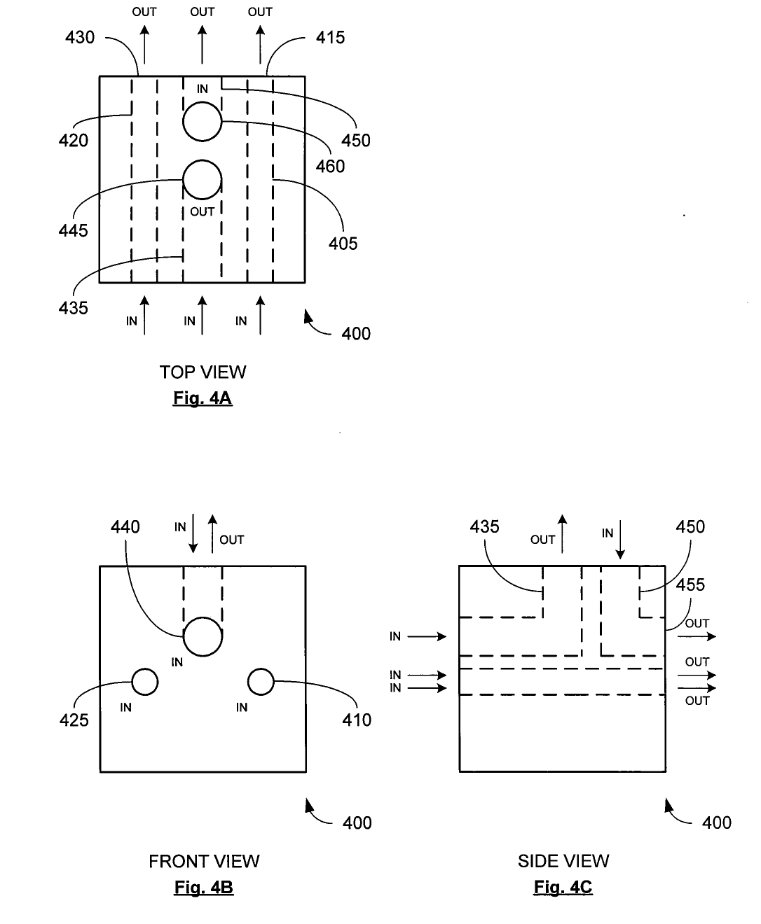

In FIG. 4A, FIG. 4B and FIG. 4C, another fluid handling unit 400 is shown from three different views (top, front and side, respectively). In this embodiment, the fluid handling unit 400 has a first small fluid passage port 405 accessible by a first input orifice 410 and a first output orifice 415; a second small fluid passage port 420 accessible by a second input orifice 425 and a second output orifice 430; a first large fluid passage port 435 accessible by a third input orifice 440 and a first control orifice 445; and a second large fluid passage port 450 accessible by a third output orifice 455 and a second control orifice 460.

In one possible application of fluid handling unit 400, fluid ‘A’ flows into first input orifice 410, through first small fluid passage port 405, and to first output orifice 415. Fluid ‘B’ may flow into second input orifice 425, through second small fluid passage port 420, and to second output orifice 430. Fluid ‘C’ may flow into third input orifice 440, through first large fluid passage port 435, and to first control orifice 445. A control component may be reversibly coupled to the top of the fluid handling component 400 and may direct and regulate the flow of fluid ‘C’ from first control orifice 445 to second control orifice 460. The control component may, for example, be a valve, a flow regulator, a pressure regulator, a restrictive flow orifice, a purifier, a flow controller, a filter, a gauge, a sensor, a branch connector and/or a mechanical indicator. The regulated flow of fluid ‘C’ may then flow through large fluid passage port 450 to third output orifice 455. From third output orifice 455, the fluid ‘C’ may be delivered, for example, to a piece of fluid utilizing equipment or possibly another fluid handling unit. Likewise, Fluids ‘A’ and ‘B’ may also be delivered, for example, to a piece of fluid utilizing equipment or possibly another fluid handling unit.

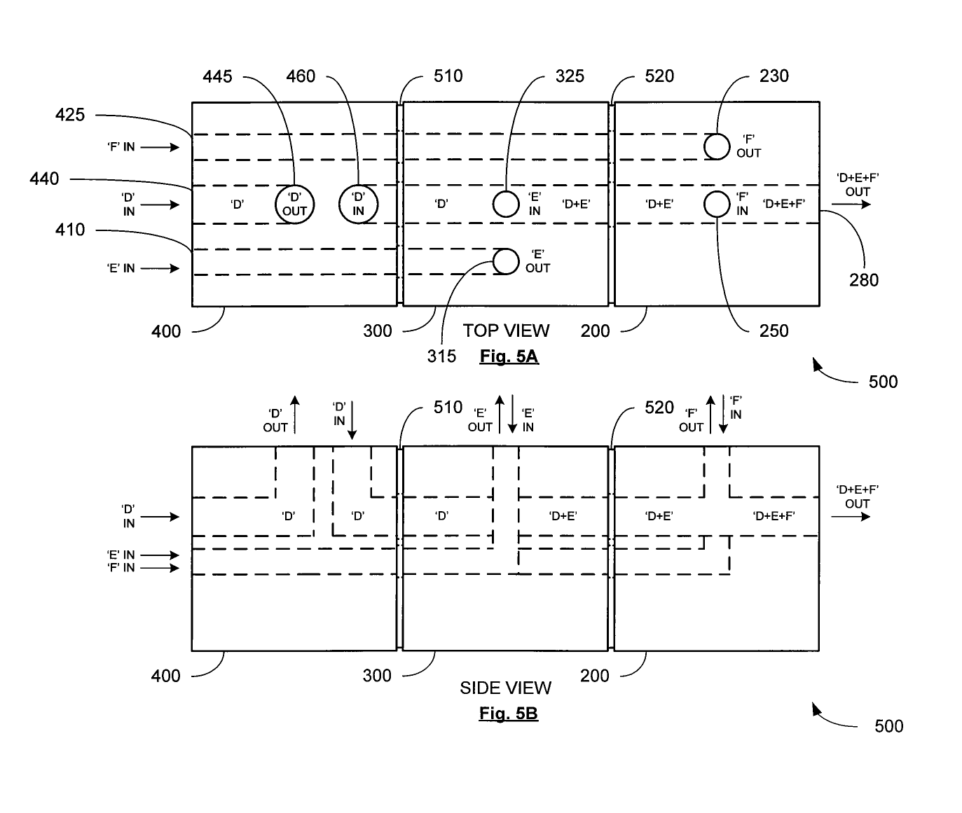

FIG. 5A and FIG. 5B show a top and a side view, respectively, of a modular fluid handling system 500 which includes the fluid handling units 200, 300, 400 from FIG. 2C, FIG. 3C, and FIG. 4C coupled together to form a plurality of fluid flow passages, some small and some large. The fluid handling units 200, 300, 400 have been coupled together with gaskets 510, 520 disposed between them to provide a leak tight seal for fluid communication between the orifices of the fluid handling units 200, 300, 400. This embodiment 500 of a modular fluid handling system may be used to combine multiple streams of low-flow fluid streams into a singular high-flow stream, though other uses are possible within the scope of the invention.

In one example mode of operation, fluids ‘D,’ ‘E’ and ‘F’ may be input to fluid handling unit 400 through input orifices 440, 410, 425 respectively. A control component may be reversibly coupled with the top of fluid handling unit 400 and fluid ‘D’ may flow into the control component through control orifice 445. The control component may regulate the flow of fluid ‘D’ and direct the regulated flow to control orifice 460. Regulated fluid ‘D’ may then flow to fluid handling unit 300. Meanwhile, fluids ‘E’ and ‘F’ may flow through fluid handling unit 400 and enter fluid handling unit 300.

Another control component may be reversibly coupled with the top of fluid handling unit 300. Fluid ‘E’ may enter the control component through control orifice 315 and be regulated and then redirected into control orifice 325. Therefore, regulated fluid ‘E’ will be mixed into the fluid ‘D’ stream to make a ‘D+E’ stream. The ‘D+E’ stream may flow into fluid handling unit 200. Meanwhile, fluid ‘F’ may flow through fluid handling unit 300 and enter fluid handling unit 200.

Another control component may be reversibly coupled with the top of fluid handling unit 200. Fluid ‘F’ may enter the control component through control orifice 230 and be regulated and then redirected into control orifice 250. Therefore, regulated fluid ‘F’ will be mixed into the ‘D+E’ stream to make a ‘D+E+F’ stream. The ‘D+E+F’ stream may flow into fluid handling unit 200. The ‘D+E+F’ stream may then exit the modular fluid handling system at output orifice 280 and possibly be delivered to a piece of fluid utilizing equipment. Those skilled in the will now realize that low pressure streams may be combined in such a manner with less of an increase in pressure that would occur had the streams been combined into a smaller port.

In some embodiments the modular fluid handling system 500 may be used to deliver a process, a purge, and a vacuum stream to a piece of fluid utilizing equipment. Fluid ‘D’ may be the process fluid and during normal operation fluid ‘D’ may flow to equipment as regulated by the control component coupled with fluid handling unit 400. The control components coupled with fluid handling units 200, 300 may be configured during this period of normal operation to completely prevent fluids ‘E’ and ‘F’ from entering the fluid ‘D’ stream and mixing therewith.

During a purge procedure, with fluid ‘E’ being the purge fluid, the control components coupled with fluid handling units 200, 400 may be ‘shut off’ and prevent fluids ‘D’ and ‘F’ from flowing to the equipment. The control component couple with fluid handling unit 300 may then control the flow of the purge fluid to the equipment. Similarly, fluid ‘F’ may be a vacuum stream and while the control components coupled with fluid handling units 300, 400 are shut off, the control component coupled with fluid handling unit 200 may control a vacuum stream delivered to the equipment.

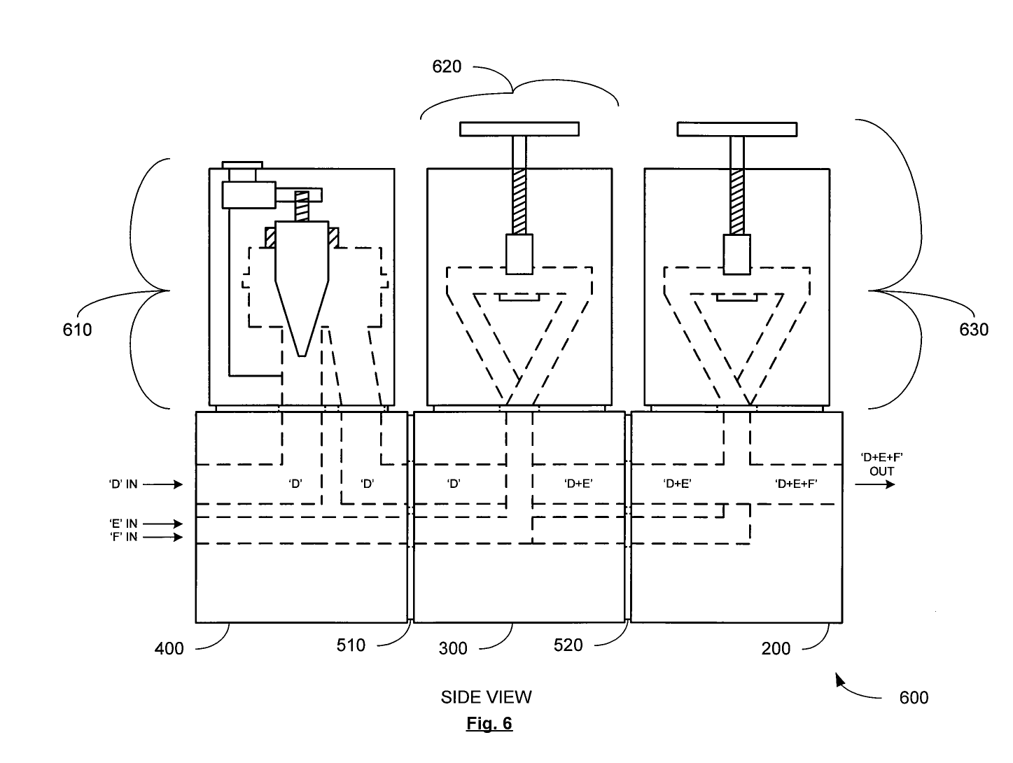

FIG. 6 shows a side view of the modular fluid handling system shown in FIG. 5A, except with a mass flow controller 610, and two shut-off valves 620, 630 also coupled with the system 600. The simplified version of the mass flow controller 610 and shut-off valves 620, 630 shown in FIG. 6 is merely for explanatory purposes and is not intended to be an exact representation of the precise structure or functionality of any particular commercially available control components. Mass flow controller 610 may be any mass flow controller known in the art and may be used to regulate the flow of fluid ‘D’ through the embodiment described above. The two shut-off valves 620, 630 may be used to allow or not allow fluids ‘E’ and ‘F’ to flow into the large fluid passage formed by the fluid handling system 600. Shut-off valve 620, as shown, enables a user to turn on or off the flow of fluid ‘E’ into the large passage port, as shut-off valve 630 does for fluid ‘F.’ Gaskets are also shown disposed between the mass flow controller 610 and shut off valves 620, 630 to provide a leak tight seal between the control components and the fluid handling units.

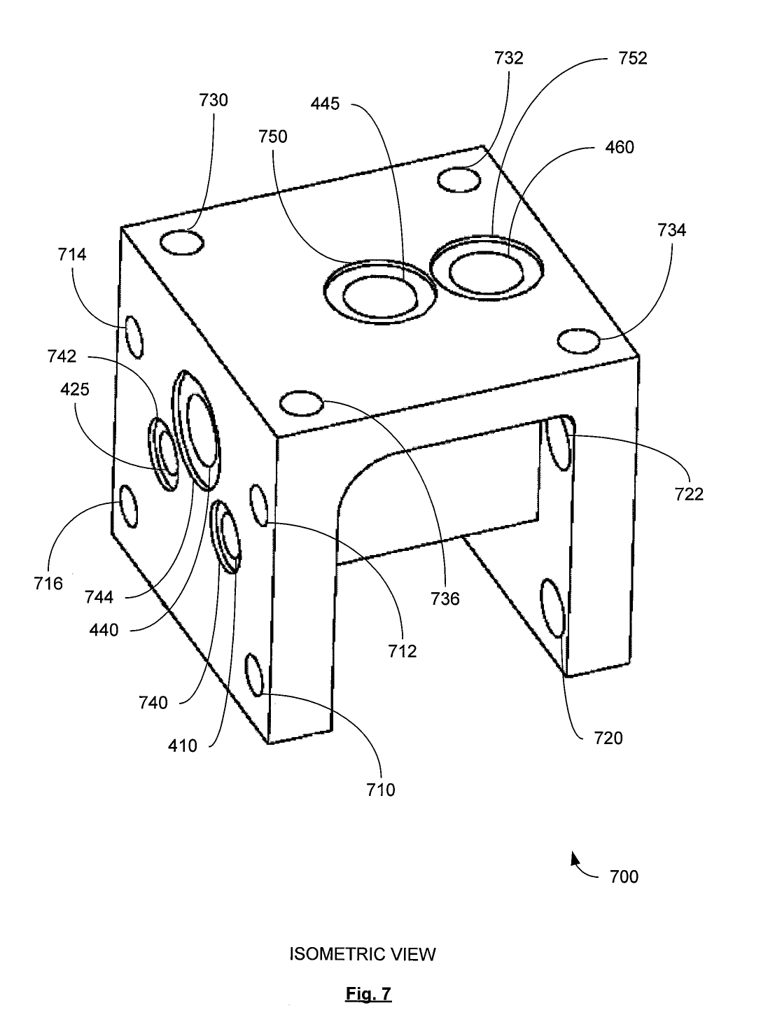

FIG. 7 shows an isometric view of another possible fluid handling unit 700 of the invention similar to that shown in FIG. 4A, FIG. 4B and FIG. 4C, except having extensions with cavities on the front, back and top of the fluid handling unit that allow for reversible coupling of the fluid handling unit to other fluid handling units. As in FIG. 4A, FIG. 4B and FIG. 4C, a first input orifice 410, a second input orifice 425, and a third input orifice 440 are visible on the front of the fluid handling unit 700. A first control orifice 445 and a second control orifice 460 are visible on the top of the fluid handling unit 700. Hidden from view in FIG. 7 are a first output orifice 415, a second output orifice 430, and a third output orifice 455, which may be seen in better detail in FIG. 4A, FIG. 4B and FIG. 4C.

Also shown on FIG. 7 are front attachment cavities 710, 712, 714, 716. Rear attachment cavities 720, 722 are also shown. Two other similarly situated rear attachment cavities are present on the other side of fluid handling unit 700, but are not visible from this perspective. Fasteners, for example bolts or machine screws, may pass through each of the front attachment cavities 710, 712, 714, 716 and then through rear attachment cavities, similar to rear attachment cavities 720, 722 on another fluid handling unit to reversibly couple the two fluid handling units together. Some or all of the attachment cavities may be threaded to facilitate the use of machine screws. In other embodiments, nuts may be used, and may be at least partially recessed into the cavities or coupled to the cavities. Other coupling methods may be employed such as cam-locking mechanisms or possibly chemical adhesives.

Further shown on the top of fluid handling unit 700 are top attachment cavities 730, 732, 734, 736. Control components which may be coupled with the top of the fluid handling unit 700 may have similarly situated attachment cavities. Fasteners, for example bolts or machine screws, may pass through each of the attachment cavities on the control components and into top attachment cavities 730, 732, 734, 736 to reversibly couple the control component to the fluid handling unit 700. Some or all of the attachment cavities may be threaded to facilitate the use of machine screws. In other embodiments, nuts may be used, and may be at least partially recessed into the cavities or coupled to the cavities. Other coupling methods may be employed such as cam-locking mechanisms or possibly chemical adhesives. FIG. 7 also shows recesses 740, 742, 744, 750, 752 around each of the orifices. mechanical seals may be disposed in these recesses to leak tightly couple adjacent fluid handling units.

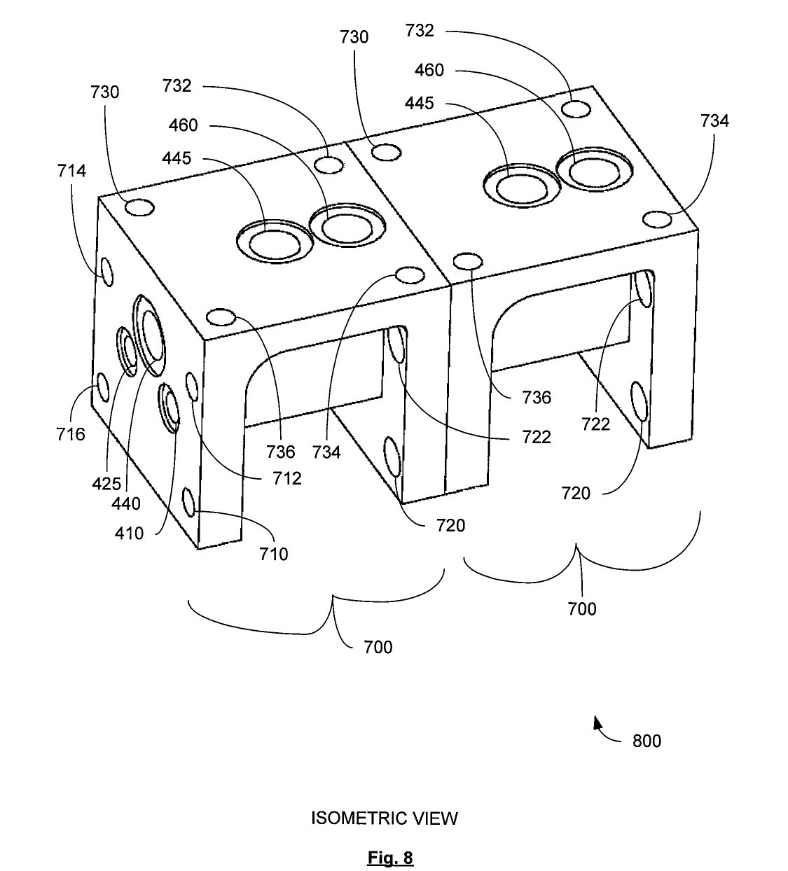

FIG. 8 shows an isometric view of two of the fluid handling units 700 from FIG. 7 situated in an orientation 800 as they may be coupled together in some embodiments of the invention. In this orientation 800, the two fluid handling units, having fluid passage ports similar to those in FIG. 4A, FIG. 4B and FIG. 4C, have created multiple fluid passages. The two smaller fluid passages are accessibly by input orifices 410, 425. Three larger fluid passages are created: a first large fluid passage is accessible by input orifice 440 and control orifice 445 on the left fluid handling unit; a second large fluid passage is accessible by control orifice 460 on the left fluid handling unit and control orifice 445 on the right fluid handling unit; and a third large fluid passage is accessible by control orifice 460 on the right fluid handling unit and an output orifice which is not visible from this perspective. Control components could be coupled with the top of both fluid handling units to control and/or monitor the fluid flow through the large fluid passages.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

As used herein and in the appended claims, the singular forms “a”, “an”, and “the” include plural referents unless the context clearly dictates otherwise. Thus, for example, reference to “a process” includes a plurality of such processes and reference to “the unit” includes reference to one or more units and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A fluid handling unit comprising:
a body;
a plurality of fluid passage ports formed in the body; and
a plurality of orifices formed on surfaces of the body to provide fluid access to the ports from outside the unit,
wherein at least two of the orifices have different cross-sectional areas.

2. The fluid handling unit of claim 1, wherein the at least two orifices are circular and have different diameters.

3. The fluid handling unit of claim 1, wherein at least two of the plurality of ports have different diameters.

4. The fluid handling unit of claim 1, wherein the body comprises:
a front face;
a back face; and
a top face.

5. The fluid handling unit of claim 4, wherein the unit comprises:
one or more input orifices on the front face of the body;
one or more output orifices on the back face of the body; and
one or more control orifices on the top face of the body.

6. The fluid handling unit of claim 5, wherein at least one of the fluid passage ports is accessible by the input orifice and the output orifice.

7. The fluid handling unit of claim 5, wherein at least one of the fluid passage ports is accessible by the control orifice.

8. The first fluid handling unit of claim 1, wherein said fluid is a liquid or a gas.

9. The first fluid handling unit of claim 5, wherein the top face of the body is adapted to be reversibly coupled with a control component having at least one component orifice.

10. The first fluid handling unit of claim 9, wherein when the top face of the body is reversibly coupled with the control component, at least one control orifice will be in fluid communication with at least one component orifice.

11. The first fluid handling unit of claim 9, wherein when coupled, a mechanical seal is disposed between the first fluid handling unit and the control component to leak tightly couple the first fluid handling unit and the control component.

12. The first fluid handling unit of claim 11, wherein the mechanical seal is a selection from a group consisting of:
a chemical adhesive;
a chemical sealant;
a gasket; and
an o-ring.

13. The first fluid handling unit of claim 9, wherein the control component is a selection from the group consisting of:
a valve;
a flow regulator;
a pressure regulator;
a restrictive flow orifice;
a purifier;
a flow controller;
a filter;
a gauge;
a sensor;
a branch connector; and
a mechanical indicator.

14. The first fluid handling unit of claim 5, wherein the front face of the body of the fluid handling unit is adapted to be reversibly coupled with a back face of a body of a secondary fluid handling unit, the secondary fluid handling unit having at least one output orifice.

15. The first fluid handling unit of claim 14, wherein when coupled, at least one input orifice of the fluid handling unit will be in fluid communication with at least one output orifice of the secondary fluid handling unit.

16. The first fluid handling unit of claim 14, wherein when coupled, a mechanical seal is disposed between the fluid handling unit and the secondary fluid handling unit to leak tightly couple the fluid handling unit and the secondary fluid handling unit.

17. The first fluid handling unit of claim 5, wherein the back face of the body of the fluid handling unit is adapted to be reversibly coupled with a front face of a body of a secondary fluid handling unit, the secondary fluid handling unit having at least one input orifice.

18. The first fluid handling unit of claim 17, wherein when coupled, at least one output orifice of the fluid handling unit will be in fluid communication with at least one input orifice of the secondary fluid handling unit.

19. The first fluid handling unit for managing fluid flow of claim 17, wherein when coupled, a mechanical seal is disposed between the fluid handling unit and the secondary fluid handling unit to leak tightly couple the fluid handling unit and the secondary fluid handling unit.

20. A modular fluid handling system comprising:
a plurality of fluid handling units, wherein adjacent fluid handling units are coupled together to form the fluid handling system, wherein the fluid handling system delivers fluid from at least one fluid source to fluid utilizing equipment; and
wherein a plurality of fluid passages are formed from the coupled plurality of fluid handling units, and wherein the diameter of at least one fluid passage is greater than the diameter of at least one other fluid passage.

21. The modular fluid handling system of claim 20, further comprising:
at least one control component coupled with at least one of the fluid handling units.

22. The modular fluid handling system of claim 20, wherein at least one fluid passage extends through the plurality of fluid handling units.

23. The modular fluid handling system of claim 20, wherein at least one fluid passage is in fluid communication with at least one other fluid passage.

24. The modular fluid handling system of claim 23, wherein the fluid communication occurs at least in part through the control component.

25. The modular fluid handling system of claim 20, wherein a mechanical seal is disposed between adjacent fluid handling units to leak tightly couple adjacent fluid handling units together.

26. The modular fluid handling system of claim 20, wherein at least one fluid passage is coupled with the fluid source.

27. The modular fluid handling system of claim 26, wherein at least one other fluid passage is coupled with the fluid utilizing equipment.

28. A fluid delivery manifold comprising:
a plurality of fluid handling units, wherein adjacent fluid handling units are coupled together to form the fluid delivery manifold, wherein the fluid delivery manifold delivers fluid from a plurality of fluid sources to a piece of fluid utilizing equipment; and
wherein:
a high-flow fluid passage is coupled with the fluid utilizing equipment and is formed by two or more of the fluid handling units; and
a plurality of low-flow fluid passages are in fluid communication with the high-flow fluid passage and the plurality of fluid sources, wherein the low-flow fluid passages are formed by two or more of the fluid handling units and have a smaller diameter than the high-flow fluid passage.

29. The fluid delivery manifold of claim 28, further comprising at least one control component coupled with each of the low-flow fluid passages, wherein the control component regulates a rate of fluid flow from the low-flow fluid passage to the high-flow passage.

30. A fluid delivery manifold comprising:
a plurality of fluid handling units, wherein adjacent fluid handling units are coupled together to form the fluid delivery manifold, wherein the fluid delivery manifold delivers fluid from a fluid source to a plurality of pieces of fluid utilizing equipment; and
wherein:
a high-flow fluid passage is coupled with the fluid source and is formed by two or more of the fluid handling units; and
a plurality of low-flow fluid passages are in fluid communication with the high-flow fluid passage and the plurality of pieces of fluid utilizing equipment, wherein the low-flow fluid passages are formed by two or more of the fluid handling units and have a smaller diameter than the high-flow fluid passage.

31. The fluid delivery manifold of claim 30, further comprising at least one control component coupled with each of the low-flow fluid passages, wherein the control component regulates a rate of fluid flow to the low-flow fluid passages from the high-flow fluid passage.
